(19) United States
(12) Patent Application Publication
(10) Pub. No.: US 2018/0254947 A1
(43) Pub. Date: Sep. 6, 2018

(54) Method and Apparatus for Configuring an Administrative Domain

(71) Applicant: 128 Technology, Inc., Burlington, MA (US)

(72) Inventors: Michael Baj, Somerville, MA (US); Patrick J. MeLampy, Dunstable, MA (US)

(21) Appl. No.: 15/450,680

(22) Filed: Mar. 6, 2017

(51) Int. Cl. H04L 12/24; H04L 29/08

(52) U.S. Cl. CPC H04L 41/0806; H04L 67/142

(57) ABSTRACT

A router is configured to be part of an administrative domain having two or more networks that each have at least one router. The router has a configuration interface permitting programming of a given configuration parameter to a local configuration setting, and an input configured to receive, from a configuration manager remote from the router, global configuration settings for a plurality of configuration parameters. For the given configuration parameter, the plurality of global configuration settings includes a different setting that is different from the local configuration setting. The configuration interface has a local configuration mode that disregards received global configuration setting changes to the given configuration parameter after programming the given configuration parameter to the local configuration setting. Also when in the local configuration mode, the configuration interface overwrites the given configuration parameter with the local configuration setting when previously programmed to the different setting.

### FIELD OF THE INVENTION

The invention generally relates to network devices, such as routers and, more particularly, the invention relates to configuring network devices, such as routers, in an administrative domain.

### BACKGROUND OF THE INVENTION

Routers transport data across the Internet—arguably one of the foremost drivers of the modern economy. To operate effectively, those skilled in the art necessarily configure routers to ensure they operate according to the requirements of their local networks, transport protocols, and/or operators (among other things). Router configuration processes, however, continue to present technical challenges that can impede their ultimate functions. For example, if a router is misconfigured, it may not be able to transmit IP packets to another router in its network.

### SUMMARY OF VARIOUS EMBODIMENTS

In accordance with one embodiment of the invention, a method more efficiently configures an administrative domain having two or more networks that each has at least one router. To that end, the method both programs a given configuration parameter to a local configuration setting on a given router in a given network of the administrative domain, and provides a plurality of global configuration settings for a plurality of configuration parameters in the administrative domain. The plurality of global configuration settings includes a different setting (for the given configuration parameter), which is different from the local configuration setting. The method forwards the plurality of global configuration settings to a “receiving plurality of networks”, which includes the given network and a second network (and may include other networks). The plurality of global configuration settings specify programming of the given configuration parameter as the different setting—not the local configuration setting.

The method then programs the given configuration parameter to the different setting on at least one router at the second network of the receiving plurality of networks. In contrast, the given router is configured with a local configuration mode that disregards any received global configuration setting changes to the given configuration parameter after programming the given configuration parameter to the local configuration setting. Also, while in the local configuration mode, the given router overwrites the given configuration parameter with the local configuration setting if/when that parameter was previously programmed to the different setting. Thus, in short, when in the local configuration mode, the local configuration setting has a higher priority than any received global configuration setting.

The given router may receive the plurality of global configuration settings before or after programming the given configuration parameter to the local configuration setting. In either case, the local configuration setting remains. For example, when received after and the given router is in the local configuration mode, the given configuration parameter is maintained as the local configuration setting on the given router. Accordingly, in that case, the given router disregards/ignores the different setting.

In a manner like any of a variety of network devices, the at least one router at the second network operates in accordance with a specified format. The method further may translate the given configuration parameter to the specified format. In a like manner, the method may translate the given configuration parameter to the format of the given router.

The receiving plurality of networks in the administrative domain preferably includes all of the networks in the administrative domain. In that case, each network of two or more of the receiving plurality of networks can have a respective router that programs the given configuration parameter to the different setting after receipt of the plurality of global configuration settings. Among other things, the administrative domain may have a configuration manager to generate the plurality of global configuration settings. The configuration manager forwards the plurality of global configuration settings to the plurality of networks.

When programming the given configuration parameter to the prescribed setting, the method may logically access a configuration interface of the given router to program the local configuration setting on the given router. That logical access may be performed physically locally (e.g., at the network) or physically remotely (e.g., at the above noted configuration manager).

The given router may be configured with no more configuration modes than the local configuration mode, which disregards any received global configuration setting changes. Alternatively, the given router also may be configured with a global configuration mode in which the given router programs the given configuration parameter to the different setting after receipt of the plurality of global configuration settings—regardless of whether the given configuration parameter is set to the local configuration setting. In that case, unlike when in the local configuration mode, the local configuration setting may be overwritten by the different setting.

The given router also may be configured to maintain state information for a set of the packets that are part of a given session in a network having a plurality of nodes. Accordingly, in such an embodiment, the given router is configured to forward each packet in the set of packets in the given session to the same node in the network.

In accordance with another embodiment of the invention, a system more efficiently configures an administrative domain having two or more networks that each has at least one router. To that end, the system has a given configuration interface, for a given router, configured to enable programming of a given configuration parameter to a local configuration setting on the given router. This given router preferably is in a given network of the administrative domain. The system also has a configuration manager operatively coupled with the given configuration interface. The configuration is configured to provide a plurality of global configuration settings for a plurality of configuration parameters (for routers) in the administrative domain. The plurality of global configuration settings include a different setting for the given configuration parameter; specifically, the different setting is different from the local configuration setting.

The system further has an output operatively coupled with the configuration manager. The output is configured to forward the plurality of global configuration settings to a receiving plurality of networks, which includes the given network and a second network. The plurality of global configuration settings specify programming of the given configuration parameter as the different setting. The configuration manager preferably is configured to program the given configuration parameter to the different setting on at least one router at the second network of the receiving plurality of networks. In contrast, the given configuration interface to the given router is designed (i.e., configured) to configure the given router with a local configuration mode that disregards any received global configuration setting changes to the given configuration parameter after programming the given configuration parameter to the local configuration setting. In addition, the given configuration interface is designed, when in the local configuration mode, to overwrite the given configuration parameter with the local configuration setting when previously programmed to the different setting.

In accordance with other embodiments of the invention, a router is configured to be part of an administrative domain having two or more networks that each has at least one router. The router has a configuration interface configured to permit programming of (i.e., setting of) a given configuration parameter to a local configuration setting, and an input operatively coupled with the configuration interface. The input is configured to receive, from a configuration manager remote from the router, a plurality of global configuration settings for a plurality of configuration parameters. For the given configuration parameter, however, the plurality of global configuration settings includes a different setting that, as its name indicates, is different from the local configuration setting.

The configuration interface is designed with a local configuration mode that disregards any received global configuration setting changes to the given configuration parameter after programming the given configuration parameter to the local configuration setting. In a similar manner, the configuration interface is configured, when in the local configuration mode, to overwrite the given configuration parameter with the local configuration setting when/if previously programmed to the different setting.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a hypothetical prior art network that may implement illustrative embodiments of the invention.

FIG. 2 schematically illustrates a prior art technique for fragmenting a message.

FIG. 3 schematically shows a hypothetical internet that may implement illustrative embodiments of the invention.

FIG. 4 schematically shows an administrative domain that may implement illustrative embodiments of the invention.

FIG. 5 schematically shows a configuration interface that efficiently configures routers in accordance with illustrative embodiments of the invention.

FIG. 6 shows a process of providing and forwarding global configuration parameters to a plurality of routers in accordance with illustrative embodiments of the invention.

FIG. 7 shows a process used by the configuration interface of FIG. 5 to configure a router in accordance with illustrative embodiments of the invention.

FIG. 8 schematically shows a hypothetical internet that includes a conventional routers and augmented IP routers (AIPRs), according to an embodiment of the present invention.

FIG. 9 schematically shows a layout of an Ethernet header, identifying fields used for identifying a beginning of a session, according to an embodiment of the present invention.

FIG. 10 schematically shows a layout of an IP header, identifying fields used for identifying a beginning of a session, according to an embodiment of the present invention.

FIG. 11 schematically shows a layout of a TCP header, identifying fields used for identifying a beginning of a session, according to an embodiment of the present invention.

FIG. 12 schematically shows a block diagram of an AIPR of FIG. 8, according to an embodiment of the present invention.

FIG. 13 shows a schematic illustration of information stored in an information base by the AIPR of FIGS. 8 and 12, according to an embodiment of the present invention.

FIG. 14 schematically shows a modified lead packet produced by the AIPR of FIG. 9, according to an embodiment of the present invention.

FIGS. 15 and 16 show flowcharts illustrating operations performed by the AIPR of FIGS. 8 and 12, according to an embodiment of the present invention.

### DESCRIPTION OF ILLUSTRATIVE EMBODIMENTS

In illustrative embodiments, an administrative domain more efficiently configures a plurality of its networks. Specifically, rather than requiring each of the individual networks to configure their routers, a configuration manager globally configures routers in the networks. This global configuration is expected to provide effective configuration settings for a large number of the routers in the administrative domain. Despite that, there may be some local policies, or other local issues that conflict with the global configuration settings. To obviate that problem, the system enables the networks to override the global configurations with local configuration settings. After the local configuration settings are set on a local router, they preferably remain even after the local router receives new or different global configuration settings. Details of various embodiments are discussed below.

### Networks

Illustrative embodiments preferably are implemented on a conventional computer network. Among other things, a network includes at least two nodes and at least one link between the nodes. Nodes can include computing devices (sometimes referred to as hosts) and routers. Computers include personal computers, smart phones, automatic teller machines (ATMs) and many other types of equipment that include processors and network interfaces. Links include wired and wireless connections between pairs of nodes. In addition, nodes and/or links may be implemented completely in software, such as in a virtual machine, a software defined network, and using network function virtualization. Many networks include switches, which are largely transparent for purposes of this discussion. However, some switches also perform routing functions. For the present discussion, such routing switches are considered routers. Routers are described below.

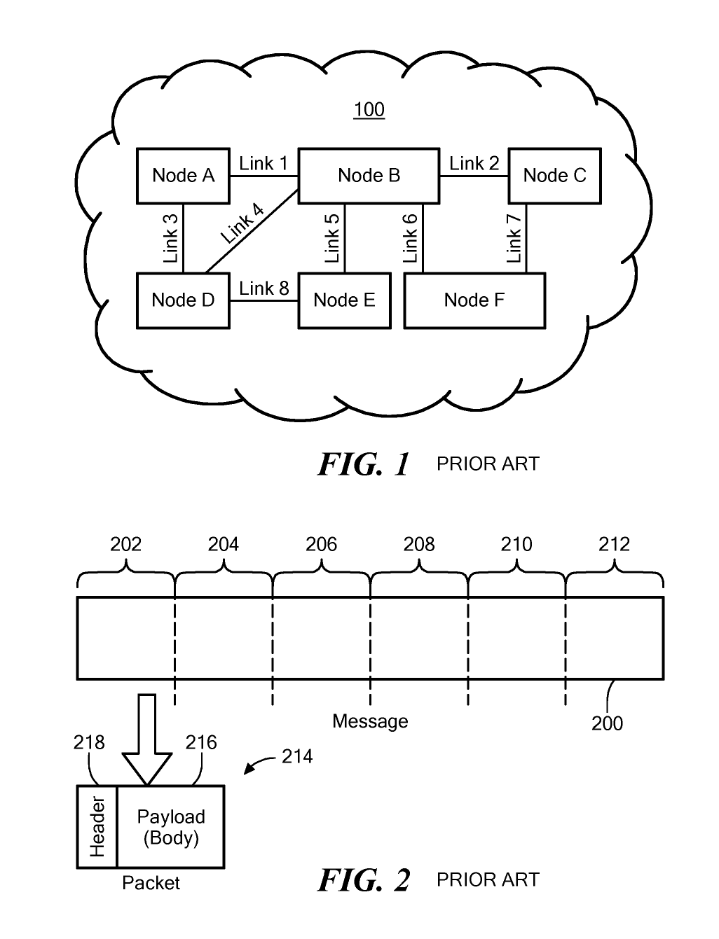

A node can be directly connected to one or more other nodes, each via a distinct link. For example, FIG. 1 schematically shows a Node A directly connected to Node B via Link 1. In a given network (e.g., within a local area network), each node has a unique network address to facilitate sending and receiving data. A network includes all the nodes addressable within the network according to the network's addressing scheme and all the links that interconnect the nodes for communication according to the network's addressing scheme. For example, in FIG. 1, Node A, Node B, Node C, . . . Node F and all the links 1-8 together make up a network 100. For simplicity, a network is depicted as a cloud or as being enclosed within a cloud.

Nodes initiate communications with other nodes via the network, and nodes receive communications initiated by other nodes via the network. For example, a node may transmit/forward/send data (a message) to a directly connected (adjacent) node by sending the message via the link that interconnects the adjacent nodes. The message includes the network address of the sending node (the “source address”) and the network address of the intended receiving node (the “destination address”). A sending node can send a message to a non-adjacent node via one or more other nodes. For example, Node D may send a message to Node F via Node B. Using well known networking protocols, the node(s) between the source and the destination forward the message until the message reaches its destination. Accordingly, to operate properly, network protocols enable nodes to learn or discover network addresses of non-adjacent nodes in their network.

Nodes communicate via networks according to protocols, such as the well-known Internet Protocol (IP) and above noted Transmission Control Protocol (TCP). The protocols are typically implemented by layered software and/or hardware components according to the well-known seven-layer Open System Interconnect (OSI) model. As an example, IP operates at OSI Layer 3 (Network Layer), while the TCP operates largely at OSI Layer 4 (Transport Layer). Each layer performs a logical function and abstracts the layer below it, therefore hiding details of the lower layer.

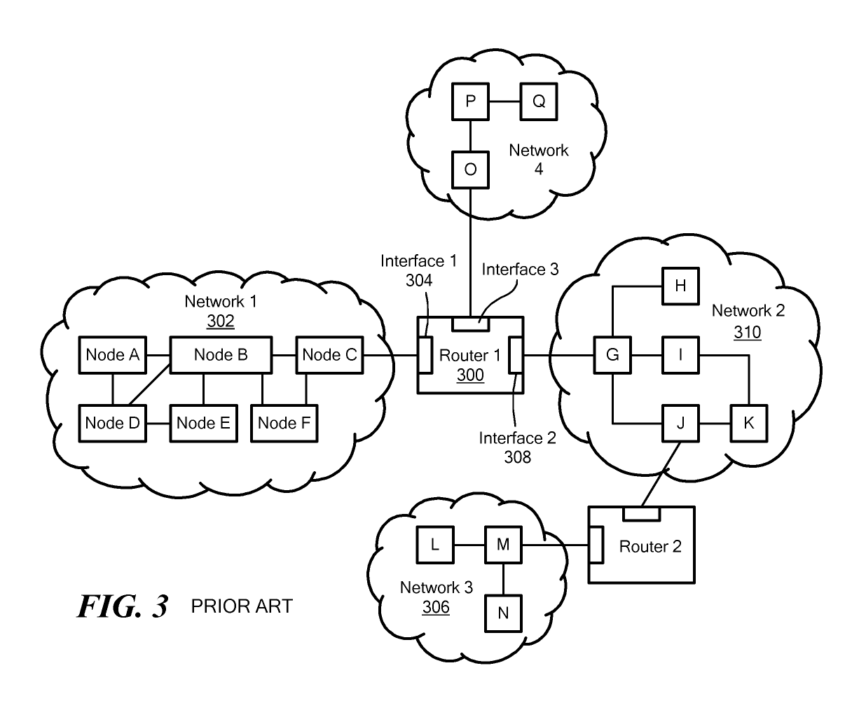

For example, Layer 3 may fragment a large message into smaller packets if Layer 2 (Data Link Layer) cannot handle the message as one transmission. FIG. 2 schematically illustrates a large message 200 divided into several pieces 202, 204, 206, 208, 210 and 212. Each piece 202-212 may then be sent in a separate packet, exemplified by packet 214. Each packet includes a payload (body) portion, exemplified by payload 216, and a header portion, exemplified at 218. The header portion 218 contains information, such as the packet's source address, destination address and packet sequence number, necessary or desirable is for: 1) routing the packet to its destination, 2) reassembling the packets of a message, and 3) other functions provided according to the protocol. In some cases, a trailer portion is also appended to the payload, such as to carry a checksum of the payload or of the entire packet. All packets of a message need not be sent along the same path, i.e., through the same nodes, on their way to their common destination. It should be noted that although IP packets are officially called IP datagrams, they are commonly referred to simply as packets.

Some other protocols also fragment data into packets. For example, the well-known TCP protocol fragments data into segments, officially referred to as TCP protocol data units (PDUs). Nevertheless, in common usage, the term packet is used to refer to PDUs and datagrams, as well as Ethernet frames.

Most protocols encapsulate packets of higher layer protocols. For example, IP encapsulates a TCP packet by adding an IP header to the TCP packet to produce an IP packet. Thus, packets sent at a lower layer can be thought of as being made up of packets within packets. Conventionally, a component operating according to a protocol examines or modifies only information within a header and/or trailer that was created by another component, typically within another node, operating according to the same protocol. That is, conventionally, components operating according to a protocol do not examine or modify portions of packets created by other protocols.

In another example of abstraction provided by layered protocols, some layers translate addresses. Some layers include layer-specific addressing schemes. For example, each end of a link is connected to a node via a real (e.g., electronic) or virtual interface, such as an Ethernet interface. At Layer 2 (Data Link Layer), each interface has an address, such as a media access control (MAC) address. On the other hand, at Layer 3 using IP, each interface, or at least each node, has an IP address. Layer 3 is used to find gateways to get an IP packet from the source to the destination.

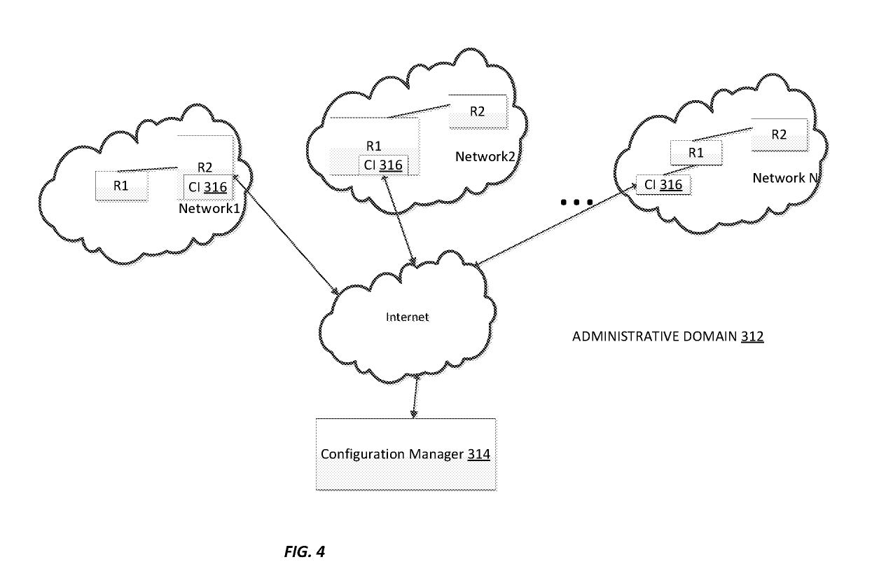

A router typically acts as a node that interconnects two or more distinct networks or two or more sub-networks (subnets) of a single network, thereby creating a “network of networks” (i.e., an internet). Thus, a router has at least two interfaces; i.e., one where each interface connects the router to a different network, as exemplified in FIG. 3. When a router receives a packet via one interface from one network, it uses information stored in its routing table to direct the packet to another network via another interface. The routing table thus contains network/next hop associations. These associations tell the router that a particular destination can optimally be reached by sending the packet to a specific router that represents a next hop on the way to the final destination. For example, if Router 1 300 receives a packet, via its Interface 1 304, from Network 1 302, and the packet is destined to a node in Network 3 306, the Router 1 300 consults its router table and then forwards the packet via its Interface 2 308 to Network 2 310. Network 2 310 will then forward the packet to Network 3 306. The next hop association can also be indicated in the routing table as an outgoing (exit) interface to the final destination.

Large organizations, such as large corporations, commercial data centers and telecommunications providers, often employ sets of routers in hierarchies to carry internal traffic. For example, one or more gateway routers may interconnect each organization's network to one or more Internet service providers (ISPs). ISPs also employ routers in hierarchies to carry traffic between their customers' gateways, to interconnect with other ISPs, and to interconnect with core routers in the Internet backbone.

A router is considered a Layer 3 device because its primary forwarding decision is based on the information in the Layer 3 IP packet—specifically the destination IP address. A conventional router does not look into the actual data contents (i.e., the encapsulated payload) that the packet carries. Instead, the router only looks at the Layer 3 addresses to make a forwarding decision, plus optionally other information in the header for hints, such as quality of service (QoS) requirements. Once a packet is forwarded, a conventional router does not retain any historical information about the packet, although the forwarding action may be collected to generate statistical data if the router is so configured. Illustrative embodiments discussed below relate to an improved apparatus and method for optimizing statistical data generation and collection.

As noted, when a router receives a packet via one interface from one network, the router uses its routing table to direct the packet to another network. Table 1 lists information typically found in a basic IP routing table.

TABLE 1

| | |
|---|---|
| Destination | Partial IP address (Expressed as a bit-mask) or Complete |
| | IP address of a packet's final destination |
| Next hop | IP address to which the packet should be forwarded on its |
| | way to the final destination |
| Interface | Outgoing network interface to use to forward the packet |
| Cost/Metric | Cost of this path, relative to costs of other possible paths |
| Routes | Information about subnets, including how to reach subnets |
| | that are not directly attached to the router, via one or more |
| | hops; default routes to use for certain types of traffic or |
| | when information is lacking |

Routing tables may be filled in manually, such as by a system administrator, or dynamically by the router. The router uses routing protocols to exchange information with other routers and, thereby, dynamically learns about surrounding network or internet topology. For example, routers announce their presence in the network(s), more specifically, the range of IP addresses to which the routers can forward packets. Neighboring routers update their routing tables with this information and broadcast their ability to forward packets to the network(s) of the first router. This information eventually spreads to more distant routers in a network. Dynamic routing allows a router to respond to changes in a network or internet, such as increased network congestion, new routers joining an internet and router or link failures.

A routing table therefore provides a set of rules for routing packets to their respective destinations. When a packet arrives, a router examines the packet's contents, such as its destination address, and finds the best matching rule in the routing table. The rule essentially tells the router which interface to use to forward the packet and the IP address of a node to which the packet is forwarded on its way to its final destination IP address.

With hop-by-hop routing, each routing table lists, for all reachable destinations, the address of the next node along a path to that destination, i.e., the next hop. Assuming that the routing tables are consistent, a simple algorithm of each router relaying packets to their destinations' respective next hop suffices to deliver packets anywhere in a network. Hop-by-hop is a fundamental characteristic of the IP Internetwork Layer and the OSI Network Layer.

Thus, each router's routing table typically merely contains information sufficient to forward a packet to another router that is “closer” to the packet's destination, without a guarantee of the packet ever being delivered to its destination. In a sense, a packet finds its way to its destination by visiting a series of routers and, at each router, using then-current rules to decide which router to visit next, with the hope that at least most packets ultimately reach their destinations.

Note that the rules may change between two successive hops of a packet or between two successive packets of a message, such as if a router becomes congested or a link fails. Two packets of a message may, therefore, follow different paths and even arrive out of order. In other words, when a packet is sent by a source node, there is no predetermined path the packet will take between the source node and the packet's destination. Instead, the path typically is dynamically determined as the packet traverses the various routers. This may be referred to as “natural routing,” i.e., a path is determined dynamically as the packet traverses the internet.

It should be noted that conventionally, packets sent by the destination node back to the source node may follow different paths than the packets from the source node to the destination node.

In many situations, a client computer node establishes a session with a server computer node, and the client and server exchange packets within the session. For example, a client computer executing a browser may establish a session with a web server. The client may send one or more packets to request a web page, and the web server may respond with one or more packets containing contents of the web page. In some types of sessions, this back-and-forth exchange of packets may continue for several cycles. In some types of sessions, packets may be sent asynchronously between the two nodes.

A session has its conventional meaning; namely, it is a plurality of packets sent by one node to another node, where all the packets are related, according to a protocol. A session may be thought of as including a lead (or initial) packet that begins the session, and one or more subsequent packets of the session. A session has a definite beginning and a definite end. For example, a TCP session is initiated by a SYN packet. In some cases, the end may be defined by a prescribed packet or series of packets. For example, a TCP session may be ended with a FIN exchange or an RST. In other cases, the end may be defined by lack of communication between the nodes for at least a predetermined amount of time (a timeout time). For example, a TCP session may be ended after a defined timeout period. Some sessions include only packets sent from one node to the other node. Other sessions include response packets, as in the web client/server interaction example. A session may include any number of cycles of back-and-forth communication, or asynchronous communication, according to the protocol, but all packets of a session are exchanged between the same client/server pair of nodes. A session is also referred to herein as a series of packets.

A computer having a single IP address may provide several services, such as web services, e-mail services and file transfer (FTP) services. The number of addresses a computer has is orthogonal to the number of services it may provide, although it has at least one. Each service is typically assigned a port number in the range 0-65,535 that is unique on the computer. A service is, therefore, defined by a combination of the node's IP address and the service's port number. Note that this combination is unique within the network the computer is connected to, and it is often unique within an internet. Similarly, a single node may execute many clients. Therefore, a client that makes a request to a service is assigned a unique port number on the client's node, so return packets from the service can be uniquely addressed to the client that made the request.

The term socket means an IP address-port number combination. Thus, each service has a network-unique, and often internet-unique, service socket, and a client making a request of a service is assigned a network-unique, and sometimes internet-unique, client socket. In places, the terms source client and destination service are used when referring to a client that sends packets to make requests of a service and the service being requested, respectively.

### Router Configuration in an Administrative Domain

As noted above, illustrative embodiments efficiently configure an administrative domain by forwarding global configuration settings to a plurality of its networks. A local configuration setting, however, preferably has a higher priority than a global configuration setting, thus enabling fine tuning of the global configuration.

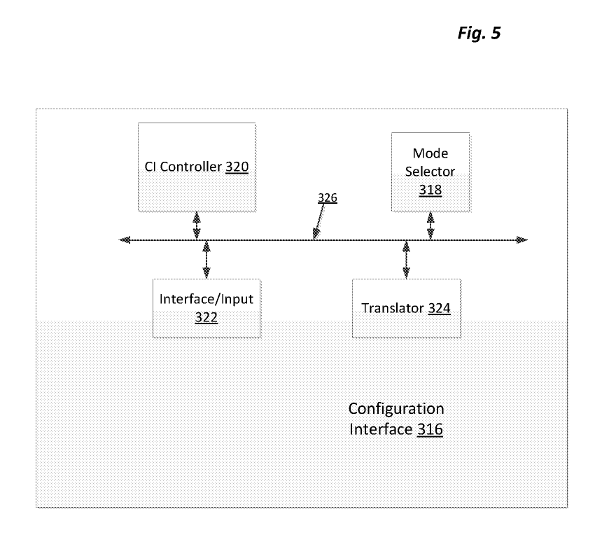

FIG. 4 schematically illustrates a generic administrative domain 312 that may implement illustrative embodiments of the invention. In this example, the administrative domain 312 has a plurality of geographically spaced apart networks (sometimes, in certain contexts, referred as “branches”) that communicate with each other through a larger network, such as the Internet (the Internet facilitates communication and, as known by those in the art, is not considered part of the administrative domain 312). Among other things, these networks may be in different cities, countries, in the same campus (e.g., different buildings of a college campus), and/or in the same room. For example, routers in different buildings of a single campus may be part of a single network. A network administrator may provision the networks depending on the requirements of its applications. As noted, however, some embodiments do not require geographically spaced apart networks.

For simplicity, this figure identifies the networks as “Network 1,” “Network 2,” and “Network N.” Indeed, the administrative domain may have a small number of networks, such as two or three networks, or a large number of networks, such as hundreds or thousands of networks. Each network has one or more routers for routing network traffic from the local network across the Internet. For convenience, FIG. 4 shows two routers on each network, and is those routers are identified as “R1” and “R2.” Of course, the router R1 on Network 1 is a different router than router R1 on the other networks.

As known by those in the art, an administrative domain is a network within a single enterprise or entity that is administered by that entity. Among others, an administrative domain may be part of a network serving a telecommunications company, a multinational corporation, a data center, a college, or a retail chain. For example, an administrative domain may be a corporate network spanning different geographic regions and managed by a single office or department. Each region has a network, such as one of those shown in FIG. 4. The networks and network devices (e.g., voice systems, switches, firewalls, load balancers, etc.) within an administrative domain operate mostly with mutual trust and treat all outside entities with suspicion. For large entities with networks across the world, an administrative domain allows the efficient sharing of data and dissemination of information, without strict security interfering with the communication network. Information is typically believed to be safe from outsiders.

In accordance with illustrative embodiments of the invention, the administrative domain 312 also has a central configuration manager 314 that globally configures a plurality of the routers in the various networks. Specifically, as noted above, an agent, such as user or logic (e.g., an artificial intelligence or application), generates global configuration settings for a plurality of global configuration parameters to be used by the routers in the administrative domain 312. As discussed in greater detail below, these specific global configuration parameters are propagated across the Internet and to some or all of the networks in the administrative domain 312. A configuration interface 316 at each of the respective networks receives these global configuration settings and takes appropriate action, as discussed below. Accordingly, each of the networks has one or more configuration interfaces 316 that configures the local routers. Those configuration interfaces 316 may be physically and/or logically part of one of the routers (e.g., Networks 1 and 2), or physically and/or logically separate from the routers (e.g., Network N).

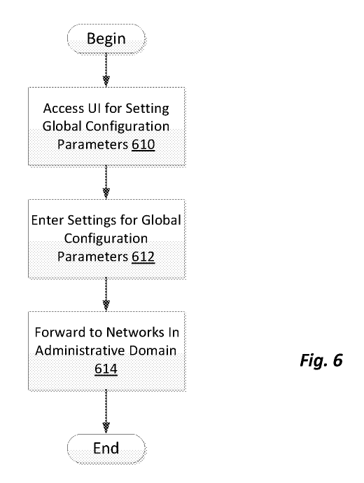

FIG. 5 schematically shows the configuration interfaces 316 of FIG. 4 in accordance with illustrative embodiments of the invention. Specifically, the configuration interface 316 has a mode selector 318 that enables the user, router, or other logic to select either a local configuration mode, in which local configuration settings have priority over global configuration settings, or a global configuration mode, in which global configurations have priority over other configuration settings. To that end, when in the local configuration mode, local router configuration settings that differ from global configuration settings persist despite receipt of updated global configuration settings from the configuration manager 314.

In addition, when in the local configuration mode, a user or administrator may access a user interface of the configuration interface 316 to set certain confirmation parameters locally. This access may be at the same physical location, or at the same logical location (e.g., remotely accessing the configuration interface 316 using a virtual private network). Those local settings do not propagate outside of the specific local network or, in some cases, not beyond a specific router. Some embodiments permit local configuration parameter setting in other modes.

Accordingly, as discussed below, when in a local configuration mode, the configuration interface 316 disregards received global configuration parameter changes to any given configuration parameter after the given configuration parameter was set/programmed to be the local configuration setting. In addition, when in this local configuration mode, the configuration interface 316 causes the router to overwrite the given configuration parameter with the local configuration setting when that parameter was previously programmed to the different global configuration setting.

Despite the higher priority of local configuration settings when in the local configuration mode, the configuration interface 316 still applies global configuration settings to the routers in certain circumstances. Specifically, if the configuration interface 316 receives a global configuration setting for a configuration parameter, and that configuration parameter is not already set to a local configuration setting, then the configuration interface 316 will program its router with the global configuration setting. Illustrative embodiments, however, overwrite that global configuration setting if it subsequently receives a local configuration setting for that configuration parameter. In addition, after being overwritten with the local configuration setting, that local configuration parameter will remain despite receipt of later received global configuration parameters. At some later time, however, the administrator or logic of that router may change the local configuration setting to a different value/requirement. Accordingly, the local configuration setting preferably has priority at least over received global configuration settings, but not over other types of received configuration settings (e.g., administrator changed configuration settings). Locally changed settings therefore may override prior or certain other local configuration settings.

Conversely, when in the global configuration mode, the global configuration settings have priority. In some embodiments, the mode selector 318 does not have a global configuration setting. Instead, it may only have one mode; namely, the local configuration mode. Other embodiments may have an administrator mode that enables an administrator to otherwise manage the configurations. For example, those embodiments may have only the local configuration mode and the administrator mode.

The configuration interface 316 also has a CI controller 320 to direct the implementation of the configuration settings and otherwise control other functions of the configuration interface 316 and an interface/input 322 for receiving/transmitting information and communicating with devices external to the configuration interface 316. For example, the interface/input 322 may receive global configuration settings from the configuration manager 314. As another example, the interface/input 322 may receive local configuration settings from a local administrator or user.

A global configuration scheme, however, suffers from a number of serious technical problems. Specifically, different routers often operate different instances or versions of software (e.g., their routing software). Accordingly, a specific global configuration setting may be compatible and recognizable for one router, while the same specific global configuration setting may be unrecognizable or have a different effect on a different router running a different version of software. To overcome this technical problem, illustrative embodiments also have a translator 324 that translates received global configuration settings into a format that is compatible with the current version of software running on the router. To maintain its accuracy, an administrator or other provider may update the translator 324 as new versions of software and new configuration settings are developed. In addition, as discussed herein, the ability to customize the local configuration settings in the local configuration mode further obviates this technical problem.

As shown, the configuration interface 316 has a plurality of components operatively connected to each other by a conventional interconnect mechanism. FIG. 5 simply shows a bus 326 communicating each the components. Those is skilled in the art should understand that this generalized representation can be modified to include other conventional direct or indirect connections. Accordingly, discussion of the bus 326 is not intended to limit various embodiments.

Indeed, it should be noted that FIG. 5 only schematically shows each of the discussed components (i.e., the CI controller 320, mode selector 318, interface/input 322, bus 326, and the translator 324). Those skilled in the art should understand that each of these components can be implemented in a variety of conventional manners, such as by using hardware, software, or a combination of hardware and software, across one or more other functional components. For example, the CI controller 320 may be implemented using a plurality of microprocessors executing firmware. As another example, the CI controller 320 may be implemented using one or more application specific integrated circuits (i.e., “ASICs”) and related software, or a combination of ASICs, discrete electronic components (e.g., transistors), and microprocessors. Accordingly, the representation of the CI controller 320 and other components in a single box of FIG. 5 is for simplicity purposes only. In fact, in some embodiments, the CI controller 320 and other components of FIG. 5 are distributed across a plurality of different machines—not necessarily within the same housing or chassis, and/or logically distinct.

It should be reiterated that the representation of FIG. 5 is a significantly simplified representation of the configuration interface 316. Those skilled in the art should understand that such a device may have other physical and functional components, such as central processing units, graphical user interfaces, and short-term memory. Accordingly, this discussion is not necessarily intended to suggest that FIG. 5 represents all of the elements of the configuration interface 316.

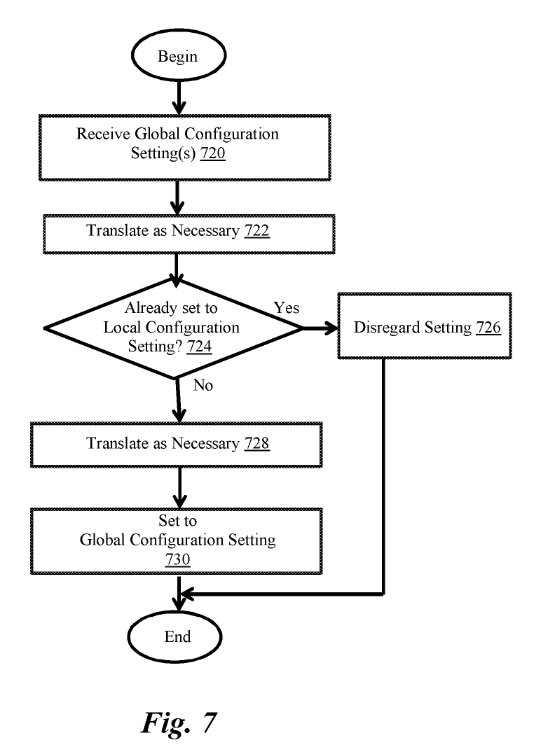

FIG. 6 shows a process of providing and forwarding global configuration parameters to a plurality of routers in accordance with illustrative embodiments of the invention. It should be noted that this process is simplified from a longer process that normally would be used to provide and forward global configuration parameters. Accordingly, the process of providing and forwarding global configuration parameters has many steps, such as policy analysis and conflict resolution steps, which those skilled in the art likely would use. In addition, some of the steps may be performed in a different order than that shown, or at the same time. Those skilled in the art therefore can modify the process as appropriate.

The process of FIG. 6 begins at step 610 in which a user, such as a systems administrator for the administrative domain 312, accesses a graphical user interface, on the configuration manager 314, for setting the global configuration parameters across the various networks. Specifically, as known by those skilled in the art, the routers operate as a function of their configuration parameters. Those parameters may control any of a variety of different functions of the router, and may be set/programmed based upon a variety of factors, such as the version of the software running on the router, corporate policies, etc. For example, some of the parameters may include prioritization of certain types of data traffic. A large retail clothing chain, for example, may generally prioritize corporate inventory traffic over social media traffic. In fact, the large retail clothing chain may prohibit social media traffic on a global level.

This prohibition, however, may cause problems with some networks. For example, a network having the marketing department of the retail clothing chain may require deep and regular access to social media, despite the global prohibition against such traffic, which may be aimed to avoid employee distraction at the various stores. Illustrative embodiments, as discussed above and below, permit the local network (i.e., the network having the marketing department in this example) to override the global configuration settings. The exception at the marketing department network therefore is a small minority of the total number of networks, thus efficiently configuring the vast majority of the store networks with the desired global configuration setting.

Indeed, administrative domains can have a wide variety of configuration parameters. A few additional examples include:
Tenant (global). This global parameter defines a network partition that is both hierarchical and named. In one implementation, the underlying Layer 3 network is abstracted away by this concept—it can be either IPv4 or IPv6. For example, engineering.128technology is a different and separate tenant from finance.128technology.
Session-type (global). This global parameter associates a given class of traffic with a set of service policies. Examples of classes of traffic are HTTP (TCP and port 80), or SIP (TCP and port 5060). Certain implementations classify this traffic so that the appropriate treatment can be applied to this traffic for the purposes of prioritization in a traffic manager.
Node (local). This local parameter defines the router software instance. For example, each node can operate in one of three roles: 1) Control, 2) Slice, or 3) Conductor. The node is where one would define the role and physical properties of the router, such as the number of device-interfaces (physical Ethernet ports) and their corresponding network-interfaces.

Below is a configuration snippet modeling the above and other examples:

```
“t128:config” : {
    “version” : 1,
    “authority-config:authority” : {
        “name” : “128”,
        “tenant” : [
          {
            “name” : “red”,
            “description” : “Tenant red”,
            “security” : “aes1”
          },
          {
            “name” : “blue”,
            “description” : “Tenant blue”,
            “security” : “aes2”
          },
          {
            “name” : “peer1-tenant”,
            “description” : “Tenant peer1”,
            “security” : “aes1”
          }
        ],
    }
}
```

Local configuration that will remain local (specifically the node config).

```
“t128:config” : {
    “version” : 1,
    “authority-config:authority” : {
        “name” : “128”,
          “system-config:node” : [
            {
              “description” : “slice 1 node”,
              “name” : “slice1”,
              “enabled” : true,
              “role” : “slice”,
              “device-interface” : [
                {
                  “id” : 10,
                  “type” : “ethernet”,
                  “pci-address” : “9999:99:99.1”,
                  “description” : “device 1”,
                  “interface-config:network-interface” : [
                    {
                      “name” : “intf1”,
                      “vlan” : 0,
                      “global-id” : 1,
                      “enabled” : true,
                      “type”: “fabric”,
                      “rewrite-dscp” : false,
                      “source-nat” : false,
                      “tenant” : “red”,
                      “qp-value” : 30,
                      “mtu” : 1500,
                      “icmp” : “allow”,
                      “address” : [
                        {
                          “prefix-length” : 16,
                          “ip-address” : “1.1.1.1”
                        },
                        {
                          “prefix-length” : 16,
                          “ip-address” : “2.2.2.2”
                        },
                        {
                          “prefix-length” : 64,
                          “ip-address” : “11::11”
                        }
                      ],
                      “neighbor” : [
                        {
                          “phys-address” : “aa:bb:cc:dd:ee:ff”,
                          “ip-address” : “1.1.1.2”
                        },
                        {
                          “phys-address” : “aa:bb:cc:dd:ee:f2”,
                          “ip-address” : “11::22”
                        }
                      ]
                    },
                  ]
                },
          }
    }
}
```

Example global configuration that can be polymorphic (specifically session-type):

```
{
  “t128:config” : {
    “version” : 1,
    “authority-config:authority” : {
        “name” : “128”,
        “service-config:service-class” : [
          {
            “name” : “class1”,
            “description” : “service class 1”,
            “dscp” : 7,
            “priority” : 0,
            “rate-limit” : true,
            “max-flow-rate” : 8000000,
            “max-flow-burst” : 800000
          }
        ],
        “service-config:session-type” : [
          {
            “name” : “session1”,
            “description” : “Session 1”,
            “service-class” : “class1”,
            “timeout” : 12345,
            “transport” : [
              {
                “protocol” : “tcp”,
                “port-range” : [
                  {
                    “start-port” : 2010,
                    “end-port” : 2010
                  },
                  {
                    “start-port” : 4010,
                    “end-port” : 4020
                  }
                ]
              }
            ]
          },
          {
            “name”: “HTTP”,
            “service-class”: “Standard”,
            “timeout”: 1900000,
            “transport”: [
              {
                “protocol”: “tcp”,
                “port-range” : [
                  {
                    “start-port”: 80,
                    “end-port”: 80
                  },
                  {
                    “start-port”: 8080,
                    “end-port”: 8080
                  }
                ]
              }
            ]
          },
```

Accordingly, the user enters specific settings for each of the global configuration parameters at step 612. Next, at step 614, the configuration manager output forwards the global configuration settings to each of the networks in the administrative domain 312. Some embodiments simply forward the specific settings to all of the networks in the administrative domain 312. Alternative embodiments, however, do not forward the specific settings to all of the networks. Instead, those alternative embodiments forward the specific settings to one or more selected networks only. The specific networks can be selected to receive the configuration settings based on their needs, policies, functions, or other reasons.

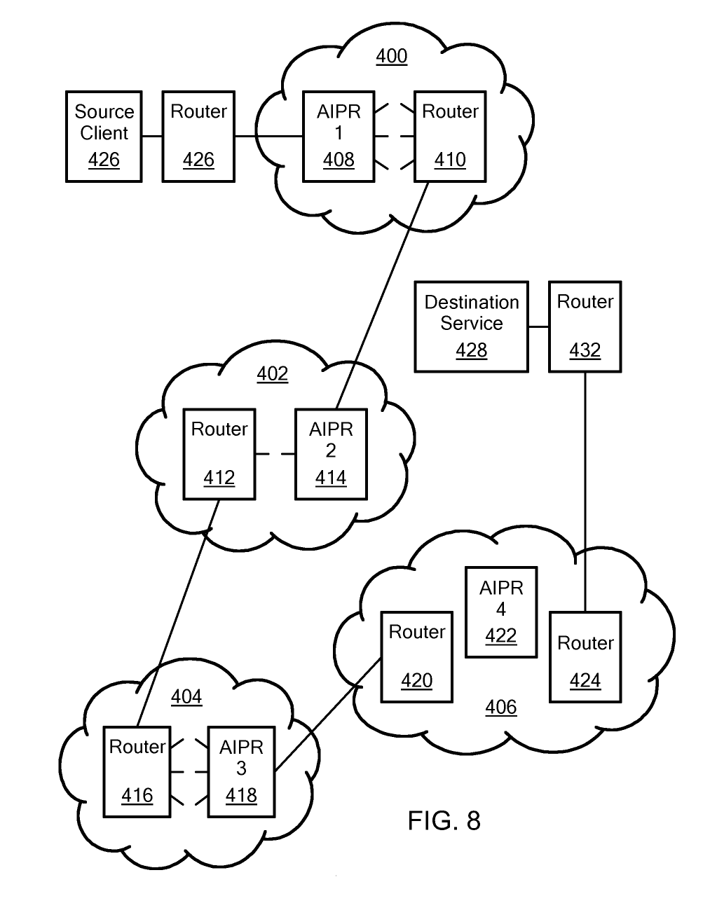

FIG. 7 shows a process used by the configuration interface 316 of FIG. 5 to configure a router in accordance with illustrative embodiments of the invention. It should be noted that this process is simplified from a longer process that normally would be used by the configuration interface 316 to configure a router. Accordingly, the process has many steps that those skilled in the art likely would use. In addition, some of the steps may be performed in a different order than that shown, or at the same time. Those skilled in the art therefore can modify the process as appropriate.

The process of FIG. 7 begins at step 720, in which the configuration interface 316 of a given network receives the global configuration settings at its local interface/input 322. The CI controller 320 then analyzes the received settings and causes the translator 324 to translate settings as needed into a format usable by the local router. For example, one of the received global configuration settings may be in a format that is not readily usable in the current version of routing software used by the relevant local router. In that case, the translator 324 translates the received global configuration setting to a format that is readily usable by the current version of routing software. Among other ways, the translator 324 may have a look up table or other data structure having the different versions of the received global configuration setting, and retrieve the appropriate global configuration setting for the current version of the routing software. Alternatively embodiments, however, skip this step and translate at a later stage of the process (discussed below).

Next, step 724 determines if the received global configuration setting was already set to a local configuration setting. Specifically, prior to this step, the user may have locally set the specific configuration parameter in question to a local configuration setting. Assuming the configuration interface 316 is in the local configuration mode, then the local configuration setting takes precedence over a global configuration setting. Accordingly, in that case, the process continues to step 726, which disregards the global configuration setting, effectively maintaining the local configuration setting. Indeed, that local configuration setting may persist until affirmatively changed to a different local is configuration setting. Despite that though, the local configuration setting preferably cannot be changed upon receipt and instructions to change the specific configuration parameter to a received global configuration setting.

Conversely, if at step 724 there was no local configuration setting for the relevant global configuration parameter, then the process can program the router with the received global configuration setting. Accordingly, the process continues to step 728, which translates the global configuration setting as needed. If it already was completely translated at step 722, then this step may be skipped.

It should be noted that step 724 may include a sub-step of determining if the received global configuration setting is the same as the current configuration setting of that configuration parameter. For example, if the received global configuration setting is the same as a previously programmed local configuration setting, then the process simply may end because the parameter does not need to be changed. If the receive global configuration setting is different than a previously programmed local configuration setting, however, then the process may continue as discussed.

The process concludes at step 730, in which the CI controller 320 sets the specific configuration parameter in question to the global configuration setting received from the configuration manager 314. This configuration setting preferably persists until the configuration interface 316 receives either a new, different global configuration setting, or a user a system administrator changes this configuration parameter to a local configuration setting.

When receiving the global configuration settings, the CI controller 320 or other component within the configuration interface 316 may determine if some or all of the routers in its local network require the received update. For example, a user or logic local to the configuration interface 316 may determine in an ad hoc manner, or based upon some systematic policy or logic, which routers is in its local network require the received global configuration setting. Alternatively, the configuration manager 314 may include directive information in its messages to the various networks directing a type of router to be updated, or the specific routers to be updated. Indeed, these updates are implemented subject to the higher priority local configuration settings as discussed above.

Accordingly, illustrative embodiments substantially streamline router configuration on a global level across an administrative domain while accounting for local idiosyncrasies/nuances. Specifically, the inventors recognized that although many routers in the administrative domain 312 may have no use for a global configuration setting, permitting local configuration settings to have a greater priority than the global settings enables parallel configuration without damaging the network. The solution therefore provides a highly scalable, robust solution to the technical problem of configuring a wide variety of routers across a vast administrative domain 312.

### Stateful Routing

In some embodiments, the packets of a session follow the same path as the lead packet of that session, at least in the forward direction, i.e., from a source client to a destination service. The subsequent packets traverse at least a subset of the routers the lead packet traverses between the source client and the destination service. Among other benefits, this stateful routing scheme more effectively enhances the benefits of collecting routing statistics. Those skilled in the art may implement such a stateful routing scheme with the configuration functionality of the administrative domain 312.

Each router in the subset is referred to herein as an intermediate node or waypoint, although the waypoints are not necessarily predetermined before the lead packet is sent by the source client. The lead packet may be naturally routed, or routed by a pre-specified path. It should be noted that although the discussion below describes use of natural routing, it should not limit various embodiments to such a scheme. If the path is not pre-specified, then the path taken by the lead packet establishes the waypoints. In either case, the subsequent packets traverse the same waypoints, and in the same order, as the lead packet.

Of course, some packets may be dropped along the way, as is typical in an IP network or internet, such as by an overloaded router or due to corruption of the packet by a link. Thus, all the packets sent by the source client need not reach the session's destination service and, consequently, all the packets sent by the source client need not traverse all the waypoints. However, subsequent packets that do reach the destination service must traverse all the waypoints. For simplicity of explanation, dropped packets are ignored in the remaining discussion, and the term “all the packets” means all the packets that reach their respective destinations.

As a result of this forward flow control, metrics collected at one of the waypoints represent all the packets of the session. These metrics are not diluted by packets that bypass the waypoint, because no packet of the session can bypass any waypoint. Security functions, such as inspection for malicious packets, performed at one waypoint are sure to be performed on all packets of the session. Importantly, this enables statistics to be calculated for specific sessions.

Some embodiments also ensure that return packets from the destination service to the source client also follow the same path, i.e., traverse the waypoints, but in reverse order. This reverse flow control enables use of paths, such as via proprietary networks, that might not otherwise be available by naturally routing the return packets.

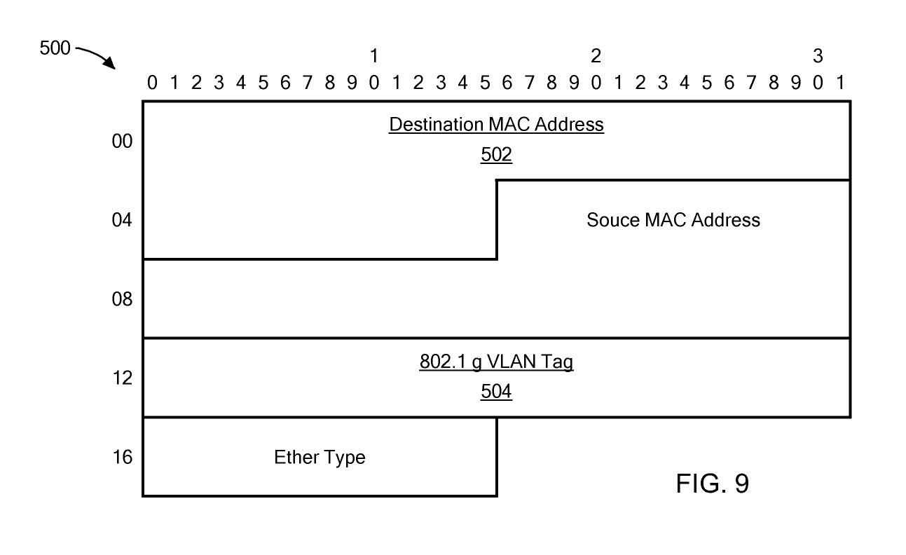

A packet flow controller (also referred to herein as an augmented IP router (“AIPR”)) ensures that subsequent packets of a session follow the same path as the lead packet of the session, as discussed above. In fact, one or both of the routers R1 and R6 of FIG. 4 may be implemented as AIPRs/waypoints. An AIPR also performs conventional routing functions, and also those described above with regard to statistics collection. FIG. 8 is a schematic diagram illustrating a hypothetical set of interconnected networks 400, 402, 404 and 406, i.e., an internet. Each network 401-406 includes a number of routers and AIPRs, not all of which are necessarily shown. Network 401 includes AIPR1 408 and router 410. Network 401 may be, for example, a network of a telecommunications carrier. Network 402 includes a router 412 and AIPR 2 414. Network 402 may be, for example, a network of a first ISP. Network 404 includes a router 416 and AIPR 3 418. Network 404 may be, for example, the Internet backbone or a portion thereof. Network 406 includes a router 420, AIPR 4 422 and another router 424. Network 406 may be, for example, a network of a second ISP.

Assume a source client node 426 initiates a session with a destination service node 428. For example, the source client 426 may request a web page, and the destination service node 428 may include a web server. The source client 426 may, for example, be part of a first local area network (LAN) (not shown) within a first corporation, and the LAN may be connected to the telecommunications carrier network 401 via a gateway router 430 operated by the corporation. Similarly, the destination service node 428 may be operated by a second corporation, and it may be part of a second LAN (not shown) coupled to the network 406 of the second ISP via a gateway router 432 operated by the second corporation. As a lead packet of the session traverses the internet, each AIPR (waypoint) the packet traverses records information that eventually enables the waypoint to be able to identify its immediately previous waypoint and its immediately next waypoint, with respect to the session.

The lead packet of the session is naturally routed. Assume the lead packet reaches AIPR 1 408 before it reaches network 402, 404 or 406. AIPR 1 408 automatically identifies the lead packet as being an initial packet of the session. AIPR 1 408 may use various techniques to identify the beginning of a session, as noted above and as discussed in more detail below. AIPR 1 408 becomes the first waypoint along a path the lead packet eventually follows.

AIPR 1 408 assigns a unique identifier to the session and stores information about the session in the AIPR's database to enable the AIPR 1 408 to identify subsequent packets of the session. In some embodiments, AIPR 1 408 reads the client socket/service socket number pair in the lead packet and stores the client socket/service socket number pair in a database to uniquely identify the session. This enables the AIPR 1 408 to identify the subsequent packets as being part of the session, because all subsequent packets of the session will contain the same client socket/service socket number pair.

In some embodiments, AIPR 1 408 sets a flag in its database to indicate the lead packet has not traversed any other AIPR before reaching AIPR 1 408. This flag may be used later, for example when the AIPR 1 408 handles return packets. AIPR 1 408 may be able to identify the lead packet as not having traversed any other AIPR by lack of any modification to the packet. Packet modification is described below.

AIPR 1 408 modifies the lead packet to indicate the lead packet has been handled by an AIPR. In some embodiments, the AIPR 1 408 stores the unique identifier of the session and, if not included in the unique identifier, the AIPR's network address in the packet to produce a modified lead packet. Subsequent AIPRs, if any, that handle the (now modified) lead packet use this modification to identify the lead packet as a lead packet that has been handled by an AIPR, and to indicate that subsequent packets of the session should be routed the same way as the lead packet is routed.

In some embodiments, AIPR 1 408 assigns a port number on the interface over which AIPR 1 408 will forward the lead packet. The AIPR's network address and this port number, in combination, may be used as a unique identifier of the session, at least from the point of view of the next AIPR along the path. AIPR 1 408 may include the AIPR's network address-port number combination in the modified lead packet. Thus, the next AIPR along the path may assume that subsequent packets sent from this network address-port number combination are part of, or likely to be part of, the session.

AIPR 1 408 then forwards the lead packet naturally. The lead packet traverses an unspecified number of nodes of network 401 until it reaches router 410, which naturally routes the lead packet to network 402. Assume the router 410 forwards the lead packet to AIPR 2 414 in network 402.

AIPR 2 414 detects the modification to the lead packet, identifying a need for special treatment. AIPR 2 414 becomes the second waypoint along the path the lead packet will follow. AIPR 2 414 stores in its database the network address of AIPR 1 408 and the port number assigned by AIPR 1 408, in association with a unique identifier of the session, such as the client and server socket number pair, thus identifying the previous waypoint along the path in association with the session. In this way, each waypoint learns the network address and port number of the previous waypoint along this session's path and uses a related association device (an “associator”) to associate this information with a session identifier. This information may be used later to forward return packets, from waypoint to waypoint, back to the source client 426.

In some embodiments, AIPR 2 414 assigns a port number on the interface over which the lead packet was received. The AIPR's network address and this port number, in combination, may be used as a unique identifier of the session, at least from the point of view of AIPR 1 408. Thus, subsequent packets addressed to this network address-port number combination may be assumed to be, or at least are likely to be, part of the session.

In some embodiments, AIPR 2 414 sends a packet back to AIPR 1 408 to inform AIPR 1 408 of the network address-port number combination, in association with the identification of the session. In some embodiments, the network address-port number combination are sent to AIPR 1 408 later, in connection with a return packet, as described below. In either case, AIPR 1 408 learns a network address-port number combination unique to the session, and

AIPR 1 408 sends subsequent packets to that address-port combination, rather than naturally forwarding the subsequent packets. In this way, each waypoint learns the network address and port number of the next waypoint along this session's path. This information is used to forward subsequent packets, from waypoint to waypoint, forward to the destination service 428, along the same path as the lead packet.

AIPR 2 214 modifies the lead packet to include the network address of AIPR 2 214, and then forwards the lead packet naturally. As with AIPR 1 408, in some embodiments AIPR 2 214 assigns a port number on the interface over which AIPR 2 214 forwards the packet, and the network address of AIPR 2 214 and the port number are included in the modified lead packet AIPR 2 214 sends.

The lead packet traverses an unspecified number of nodes of network 402, until it reaches router 412, which naturally routes the lead packet to network 404. Assume the router 416 forwards the lead packet to AIPR 3 418.

AIPR 3 418 becomes the third waypoint along the path the lead packet will follow. AIPR 3 418 operates much as AIPR 2 414. The lead packet is then forwarded to network 406, where it traverses AIPR 4 422, which becomes the fourth waypoint.

Three scenarios are possible with respect to the last AIPR 422 (AIPR 4) along the path to the destination service 428.

In the first scenario, one or more AIPRs relatively close to a destination service are provisioned to handle lead packets for the destination service. The AIPRs may be so provisioned by storing information in their databases to identify the destination service, such as by the service socket number or other unique identifier of the service. These “terminus” AIPRs broadcast their ability to forward packets to the destination service. A terminus AIPR is an AIPR that can forward packets to a destination service, without the packets traversing another AIPR. A terminus AIPR recognizes a lead packet destined to a service that terminates at the AIPR by comparing the destination service socket number to the information provisioned in the AIPR's database.

If AIPR 4 422 has been so provisioned, AIPR 4 422 may restore the lead packet to its original form, i.e., the form the lead packet had when the source client 426 sent the lead packet, or as the packet might have been modified by the router 430, such as a result of network address translation (NAT) performed by the router 430. Thus, the lead packet may be restored to a form that does not include any of the modifications made by the waypoints 408, 414 and 418. AIPR 4 422 then forwards the lead packet to the destination service 428. Like AIPR 3 418, AIPR 4 422 stores information in its database identifying AIPR 3 418 as the previous AIPR for this session.

In the second scenario, AIPR 4 422 is not provisioned with information about the destination service 428. In such embodiments, AIPR 4 422 may operate much as AIPR 2 414 and AIPR 3 418 operate. AIPR 4 422 modifies and naturally is forwards the lead packet, and the lead packet is eventually delivered to the destination service 428. The destination service 428 responds to the lead packet. For example, if the lead packet is a SYN packet to initiate a TCP session, the destination service 428 responds with an ACK or SYN/ACK packet. AIPR 4 422 recognizes the return packet as being part of the session, such as based on the source client/destination service network address/port number pairs in the return packet. Furthermore, because the return packet was sent by the destination service 428, and not another AIPR, AIPR 4 422 recognizes that it is the last AIPR along the path for this service.

AIPR 4 422 stores information in its database indicating AIPR 4 422 is a terminus AIPR. If AIPR 4 422 receives subsequent packets of the session, AIPR 4 422 may restore the subsequent packets to their original forms, i.e., the forms the subsequent packets had when the source client 426 sent the subsequent packets, or as the packets might have been modified by the router 430, such as a result of network address translation (NAT) performed by the router 430. AIPR 4 422 forwards the subsequent packets to the destination service 428.

AIPR 4 422 modifies the return packet to include a port number on the interface AIPR 4 422 received the lead packet from AIPR 3 418, as well as the network address of AIPR 4 422. AIPR 4 422, then forwards the return packet to AIPR 3 418. Although the return packet may be forwarded by other routers, AIPR 4 422 specifically addresses the return packet to AIPR 3 418. This begins the return packet's journey back along the path the lead packet traveled, through all the waypoints traversed by the lead packet, in reverse order. Thus, the return packet is not naturally routed back to the source client 426.

AIPR 3 418 receives the modified return packet and, because the return packet was addressed to the port number AIPR 3 418 previously assigned and associated with this session, AIPR 3 418 can assume the return packet is part of, or likely part of, the session. AIPR 3 418 copies the network address and port number of AIPR 4 422 from the return packet into the AIPR's database as the next waypoint for this session. If AIPR 3 418 receives subsequent packets of the session, AIPR 3 418 forwards them to the network address and port number of the next waypoint, i.e., AIPR 4 422.

Thus, once an AIPR is notified of a network address and port number of a next AIPR along a session path, the AIPR forwards subsequent packets to the next AIPR, rather than naturally routing the subsequent packets.

AIPR 3 418 forwards the return packet to AIPR 2 414, whose network address and port number were stored in the database of AIPR 3 418 and identified as the previous waypoint of the session. Likewise, each of the waypoints along the path back to the source client 426 forwards the return packet to its respective previous waypoint.

When the first waypoint, i.e., AIPR 1 408, receives the return packet, the waypoint may restore the return packet to its original form, i.e., the form the return packet had when the destination service 428 sent the return packet, or as the packet might have been modified by the router 430, such as a result of network address translation (NAT) performed by the router 430. Recall that the first waypoint set a flag in its database to indicate the lead packet had not traversed any other waypoint before reaching the first waypoint. This flag is used to signal the first waypoint to restore the return packet and forward the restored return packet to the source client 426. The first waypoint forwards the return packet to the source client 426. Subsequent return packets are similarly handled.

In the third scenario, not shown in FIG. 8, the last AIPR to receive the lead packet has a network address equal to the network address of the destination service. For example, the destination service network address may be given to a gateway router/AIPR, and the gateway router/AIPR may either process the service request or its router table may cause the packet to be forwarded to another node to perform the service. The last AIPR may restore the lead packet and subsequent packets, as described above.

It should be noted that although preferred embodiments use stateful routing as noted above, other embodiments do not use stateful routing.

Lead Packet Identification

As noted, a waypoint should be able to identify a lead packet of a session. Various techniques may be used to identify lead packets. Some of these techniques are protocol-specific. For example, a TCP session is initiated according to a well-known three-part handshake involving a SYN packet, a SYN-ACK packet and an ACK packet. By statefully following packet exchanges between pairs of nodes, a waypoint can identify a beginning of a session and, in many cases, an end of the session. For example, A TCP session may be ended by including a FIN flag in a packet and having the other node send an ACK, or by simply including an RST flag in a packet. Because each waypoint stores information about each session, such as the source client/destination service network address/port number pairs, the waypoint can identify the session with which each received packet is associated. The waypoint can follow the protocol state of each session by monitoring the messages and flags, such as SYN and FIN, sent by the endpoints of the session and storing state information about each session in its database. Such stateful monitoring of packet traffic is not taught by the prior art known to the inventor. Instead, the prior art teaches away from this type of session.

It should be noted that a SYN packet may be re-transmitted—each SYN packet does not necessarily initiate a separate session. However, the waypoint is can differentiate between SYN packets that initiate a session and re-transmitted SYN packets based on, for example, the response packets.

Where a protocol does not define a packet sequence to end a session, the waypoint may use a timer. After a predetermined amount of time, during which no packet is handled for a session, the waypoint may assume the session is ended. Such a timeout period may also be applied to sessions using protocols that define end sequences.

Table 2 describes exemplary techniques for identifying the beginning and end of a session, according to various protocols. Similar techniques may be developed for other protocols, based on the definitions of the protocols.

TABLE 2

| | Des- | |
|---|---|---|
| | tina- | |
| | tion | |
| Protocol | Port | Technique for Start/End Determination |
| TCP | Any | Detect start on the first SYN packet from a new |
| | | address/port unique within the TCP protocol's |
| | | guard time between address/port reuse. Following |
| | | the TCP state machine to determine an end (FIN |
| | | exchange, RST, or guard timeout). |
| UDP-TFTP | 69 | Trap on the first RRQ or WRQ message to define |
| | | a new session, trap on an undersized DAT packet |
| | | for an end of session. |
| UDP-SNMP | 161, | Trap on the message type, including GetRequest, |
| | 162 | SetRequest, GetNextRequest, GetBulkRequest, |
| | | InformRequest for a start of session, and monitor |
| | | the Response for end of session. For SNMP traps, |
| | | port 162 is used, and the flow of data generally |
| | | travels in the “reverse” direction. |
| UDP-SYSLOG | 514 | A single message protocol, thus each message is |
| | | a start of session, and end of session. |
| UDP-RTP | Any | RTP has a unique header structure, which can be |
| | | reviewed/analyzed to identify a start of a session. |
| | | This is not always accurate, but if used in |
| | | combination with a guard timer on the exact same |
| | | five-tuple address, it should work well enough. |
| | | The end of session is detected through a guard |
| | | timer on the five-tuple session, or a major change |
| | | in the RTP header. |
| UDP-RTCP | Any | RTCP also has a unique header, which can be |
| | | reviewed, analyzed, and harvested for analytics. |
| | | Each RTCP packet is sent periodically and can |
| | | be considered a “start of session” with |
| | | the corresponding RTCP response ending the |
| | | session. This provides a very high quality way |
| | | of getting analytics for RTCP at a network |
| | | middle point, without using a Session |
| | | Border Controller. |
| UDP-DNS | 53 | Each DNS query is a single UDP message and |
| (Nameserver) | | response. By establishing a forward session |
| | | (and subsequent backward session) the |
| | | Augmented router gets the entire transaction. This |
| | | allows analytics to be gathered and manipulations |
| | | that are appropriate at the Augmented router. |
| UDP-NTP | 123 | Each DNS query/response is a full session. So, |
| | | each query is a start, and each response is an end. |

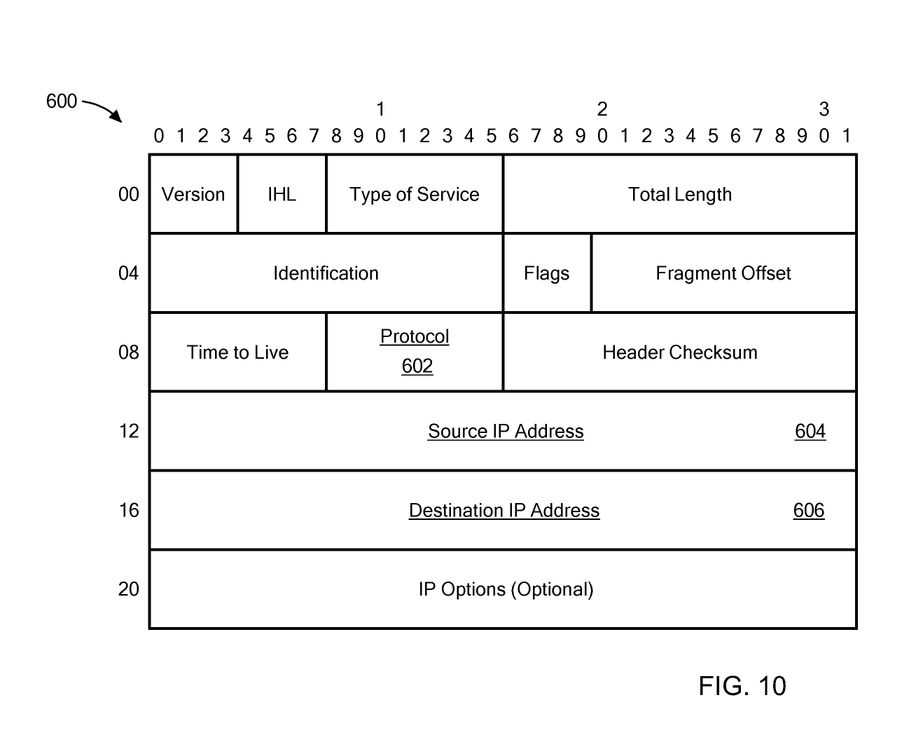

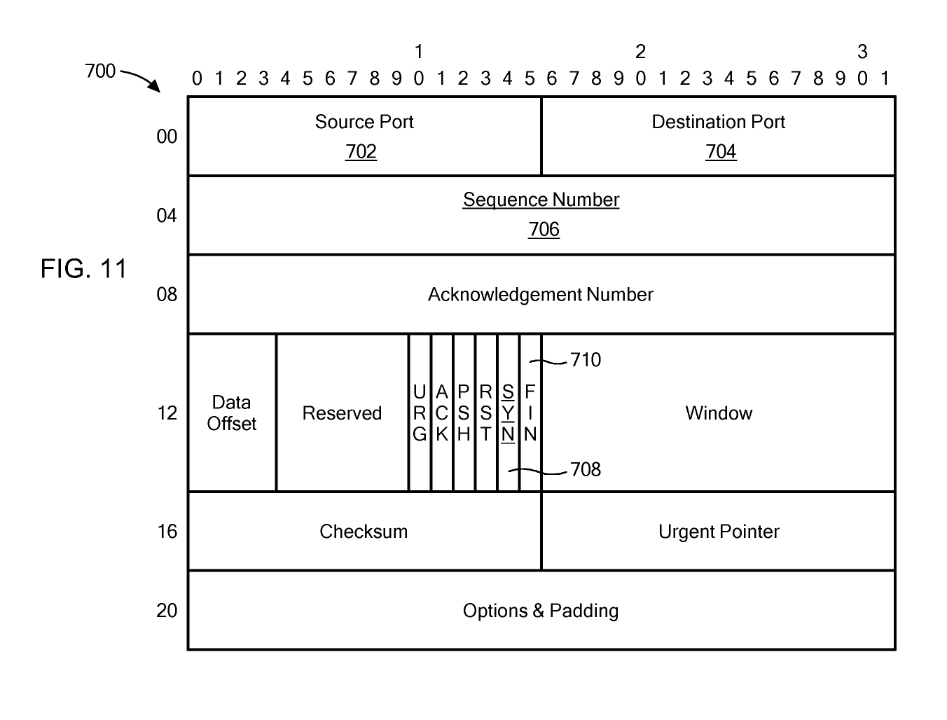

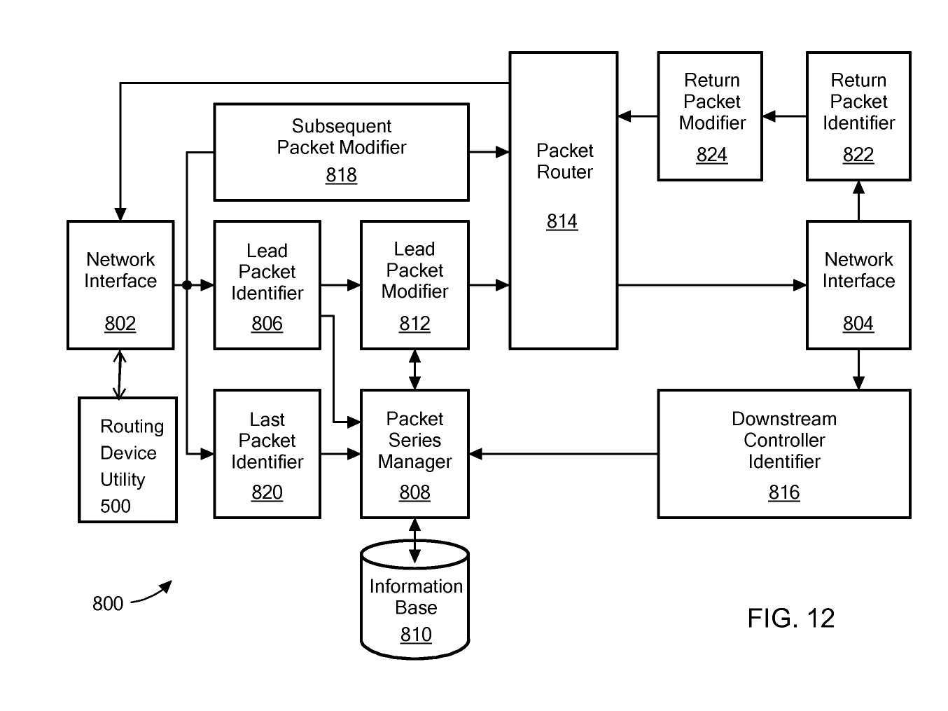

FIG. 9 is a schematic layout of an Ethernet header 500, including a Destination MAC Address 502 and an 802.1q VLAN Tag 504. FIG. 10 is a schematic layout of an IP header 600, including a Protocol field 602, a Source IP Address 604 and a Destination IP Address 606. FIG. 11 is a schematic layout of a TCP header 700, including a Source Port 702, a Destination Port 704, a Sequence Number 706, a SYN flag 708 and a FIN flag 710. These packets and the identified fields may be used to identify the beginning of a session, as summarized in Table 3.

TABLE 3

| Data Item | Where From | Description |
|---|---|---|
| Physical | Ethernet | This is the actual port that the |
| Interface | Header | message was received on, which |
| | | can be associated or discerned by |
| | | the Destination MAC Address |
| Tenant | Ethernet | Logical association with a group |
| | Header OR | of computers. |
| | Source MAD | |
| | Address & | |
| | Previous | |
| | Advertisement | |
| Protocol | IP Header | This defines the protocol in use |
| | | and, for the TCP case, it must be set |
| | | to a value that corresponds to TCP |
| Source IP | IP Header | Defines the source IP Address of |
| Address | | the initial packet of a flow. |
| Destination IP | IP Header | Defines the destination IP Address |
| Address | | of the initial packet of a flow. |
| Source Port | TCP | Defines the flow instance from the |
| | Header | source. This may reflect a client, a |
| | | firewall in front of the client, or a |
| | | carrier grade NAT. |
| Destination | TCP | This defines the desired service |
| Port | Header | requested, such as 80 for HTTP. |
| Sequence | TCP Header | This is a random number assigned |
| Number | | by the client. It may be updated by |
| | | a firewall or carrier grade NAT. |
| SYN Bit On | TCP Header | When the SYN bit is on, and no |
| | | others, this is an initial packet of a |
| | | session. It may be retransmitted if |
| | | there is no response to the first |
| | | SYN message. |

Augmented IP Router (AIPR)

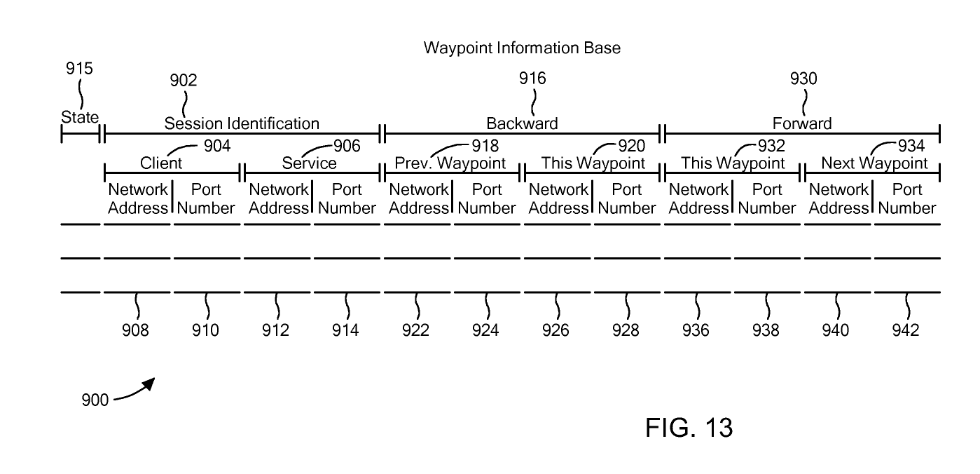

FIG. 12 is a schematic block diagram of an AIPR (waypoint) 800 configured in accordance with illustrative embodiments of the invention. In preferred embodiments, the AIPR 800 includes the configuration interface 316 of FIGS. 4 and 5. The AIPR 800 includes at least two network interfaces 802 and 804, through which the AIPR 800 may be coupled to two networks. The interfaces 802 and 804 may be, for example, Ethernet interfaces. The AIPR 800 may send and receive packets via the interfaces 802 and 804.

A lead packet identifier 806 automatically identifies lead packets, as discussed herein. In general, the lead packet identifier 806 identifies a lead packet when the lead packet identifier 806 receives a packet related to a session that is not already represented in the AIPR's information base 810, such as a packet that identifies a new source client/destination service network address/port number pair. As noted, each lead packet is an initial, non-dropped, packet of a series of packets (session). Each session includes a lead packet and at least one subsequent packet. The lead packet and all the subsequent packets are sent by the same source client toward the same destination service, for forward flow control. For forward and backward flow control, all the packets of the session are sent by either the source client or the destination service toward the other.

A session (packet series) manager 808 is coupled to the lead packet identifier 806. For each session, the session manager assigns a unique identifier. The unique identifier may be, for example, a combination of the network address of the AIPR 800 or of the interface 802, in combination with a first port number assigned by the session manager 808 for receiving subsequent packets of this session. The unique identifier may further include the network address of the AIPR 800 or of the other interface 804, in combination with a second port number assigned by the session manager 808 for transmitting the lead packet and subsequent packets. This unique identifier is associated with the session. The session manager 808 stores information about the session in an information base 810. This information may include the unique identifier, in association with the original source client/destination service network address/port number pairs.

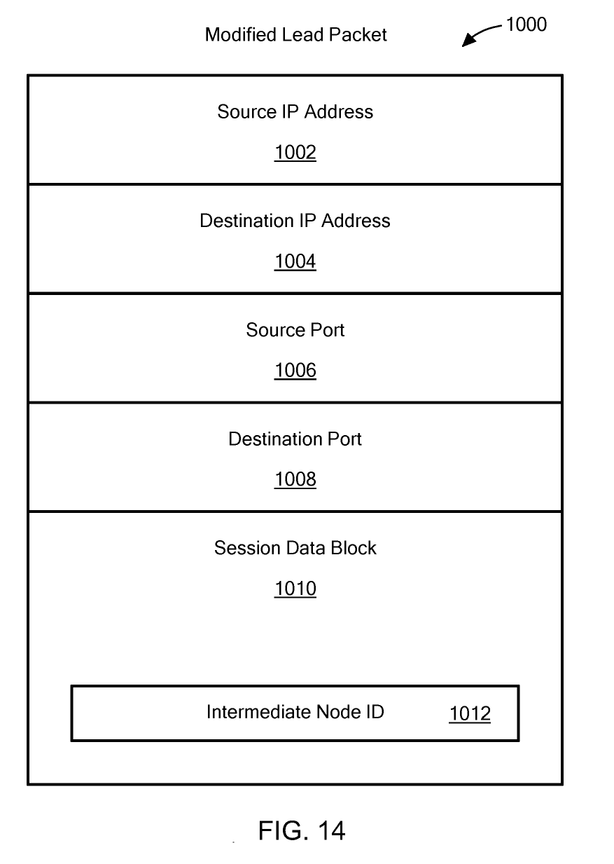

FIG. 13 is a schematic layout of an exemplary waypoint information base 900. Each row represents a session. A session identification column 902 includes sub-columns for the source client 904 and the destination service 906. For each client 904, its network address 908 and port number 910 are stored. For each destination service 906, its network address 912 and port number 914 are stored. This information is extracted from the lead packet.

State information about the session may be stored in a state column 915. This information may be used to statefully follow a series of packets, such as when a session is being initiated or ended.

A backward column includes sub-columns for storing information 916 about a portion of the backward path, specifically to the previous AIPR. The backward path information 916 includes information 918 about the previous AIPR and information 920 about the present AIPR 800. The information 918 about the previous AIPR includes the AIPR's network address 922 and port number 924. The session manager 808 extracts this information from the lead packet, assuming the lead packet was forwarded by an AIPR. If, however, the present AIPR 800 is the first AIPR to process the lead packet, the information 918 is left blank as a flag. The information 920 about the present AIPR 800 includes the network address 926 of the interface 802 over which the lead packet was received, as well as the first port number 928 assigned by session manager 808.

The waypoint information base 900 is also configured to store information 930 about a portion of the forward path, specifically to the next AIPR. This information 930 includes information 932 about the present AIPR 800 and information 934 about the next AIPR along the path, assuming there is a next AIPR. The information 932 includes the network address 936 of the interface over which the present AIPR will send the lead packet and subsequent packets, as well as the second port number 938 assigned by the session manager 808. The information 934 about the next AIPR along the path may not yet be available, unless the AIPR is provisioned with information about the forward path. The information 934 about the next AIPR includes its network address 940 and port number 942. If the information 934 about the next AIPR is not yet available, the information 934 may be filled in when the AIPR 800 processes a return packet, as described below.

Some embodiments of the waypoint information base 900 may include the forward information 930 without the backward information 916. Other embodiments of the waypoint information base 900 may include the backward information 916 without the forward information 930. Statistical information may be gathered and/or calculated using either or both forward and backward information 916.

Returning to FIG. 12, a lead packet modifier 812 is coupled to the session manager 808. The lead packet modifier 812 modifies the lead packet to store the unique identifier associated with the session. The original source client network address/port number pair, and the original destination service network address/port number pair, are stored in the modified lead packet, if necessary. The lead packet may be enlarged to accommodate the additional information stored therein, or existing space within the lead packet, such a vendor specific attribute field, may be used. Other techniques for transmitting additional information are protocol specific, for example with TCP, the additional information could be transmitted as a TCP Option field, or added to the SYN packet as data. In either case, the term session data block is used to refer to the information added to the modified lead packet.

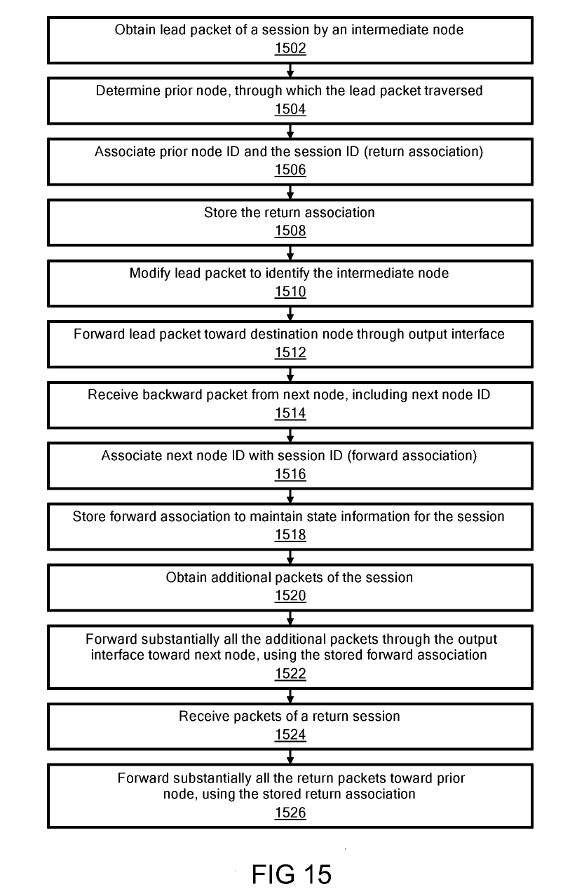

FIG. 14 is a schematic diagram of an exemplary modified lead packet 1000 showing the original source and destination IP addresses 1002 and 1004, respectively, and the original source and destination port numbers 1006 and 1008, respectively. FIG. 14 also shows a session data block 1010 in the modified lead packet 1000. Although the session data block 1010 is shown as being contiguous, it may instead have its contents distributed throughout the modified lead packet 1000. The session data block 1010 may store an identification of the sending AIPR, i.e., an intermediate node identifier 1012, such as the network address of the second network interface 804 and the second port number.

Returning to FIG. 12, the lead packet modifier 812 updates the packet length, if necessary, to reflect any enlargement of the packet. The lead packet modifier 812 updates the checksum of the packet to reflect the modifications made to the packet. The modified lead packet is then transmitted by a packet router 814, via the second network interface 804. The modified lead packet is naturally routed, unless the AIPR 800 has been provisioned with forward path information.

Eventually, the destination service sends a return packet. The AIPR 800 receives the return packet via the second interface 804. If another AIPR (downstream AIPR) between the present AIPR 800 and the destination service handles the lead packet and the return packet, the downstream AIPR modifies the return packet to include the downstream AIPR's network address and a port number. A downstream controller 816 identifier uses stateful inspection, as described herein, to identify the return packet. The downstream controller 816 stores information 934 (FIG. 13), specifically the network address and port number, about the next AIPR in the waypoint information base 900.

The present AIPR 800 may use this information to address subsequent packets to the next AIPR. Specifically, a subsequent packet modifier 818 may set the destination address of the subsequent packets to the network address and port number 940 and 942 (FIG. 13) of the next waypoint, instead of directly to the destination service. The packet router 814 sends the subsequent packets, according to their modified destination addresses. Thus, for each series of packets, subsequent packets flow through the same downstream packet flow controllers as the lead packet of the series of packets.

A last packet identifier 820 statefully follows each session to identify an end of each stream, as discussed above. As noted, in some cases, the end is signified by a final packet, such as a TCP packet with the RST flag set or a TCP ACK packet in return to a TCP packet with the FIN flag set. In other cases, the end may be signified by a timer expiring. When the end of a session is detected, the packet series manager 808 disassociates the unique identifier from the session and deletes information about the session from the waypoint information base 900.

Where the AIPR 800 is provisioned to be a last AIPR before a destination service, the lead packet modifier 806 restores the lead packet to the state the lead packet was in when the source client sent the lead packet, or as the lead packet was modified, such as a result of network address translation (NAT). Similarly, the subsequent packet modifier 818 restores subsequent packets.

Similarly, if the destination address of the lead packet is the same as the network address of the AIPR 800, or its network interface 802 over which it receives the lead packets, the lead packet modifier 806 and the subsequent packet modifier 818 restore the packet and subsequent packets.

As noted, in some protocols, several packets are required to initiate a session, as with the SYN-SYN/ACK-ACK handshake of the TCP. Thus, the downstream controller identifier 816 may wait until a second return packet is received from the destination service before considering a session as having started.

As noted, some embodiments of the waypoint 800 also manage return packet paths. The lead packet identifier 806 automatically ascertains whether a lead packet was forwarded to the waypoint 800 by an upstream waypoint. If the lead packet includes a session data block, an upstream waypoint forwarded the lead packet. The packet series manager 808 stores information about the upstream waypoint in the waypoint information base 810. A return packet identifier 822 receives return packets from the second network interface 804 and automatically identifies return packets of the session. These return packets may be identified by destination address and port number being equal to the information 932 (FIG. 13) in the waypoint information base corresponding to the session. A return packet modifier modifies the return packets to address them to the upstream waypoint for the session, as identified by the information 918 in the waypoint information base 900.

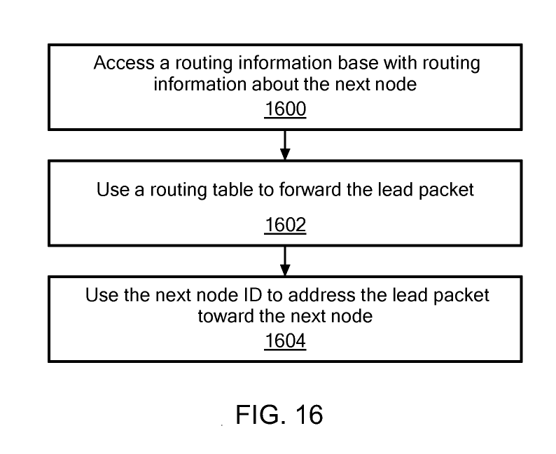

FIG. 15 shows a flowchart schematically illustrating some operations performed by the AIPR 800 (FIG. 12) in accordance with illustrative embodiments of the invention. The flowchart illustrates a packet routing method for directing packets of a session from an originating node toward a destination node in an IP network. At step 1502, an intermediate node obtains a lead packet of a plurality of packets in a session. The intermediate node may include a routing device or a switching device that performs a routing function.

The packets in the session have a unique session identifier. At step 1504, a prior node, through which the lead packet traversed, is determined. The prior node has a prior node identifier. At step 1506, a return association is formed between the prior node identifier and the session identifier. At step 1508, the return association is stored in memory to maintain state information for the session.

At step 1510, the lead packet is modified to identify at least the intermediate node. At step 1512, the lead packet is forwarded toward the destination node though an intermediate node electronic output interface to the IP network. The electronic output interface is in communication with the IP network. At step 1514, a backward message (e.g., a packet, referred to as a “backward packet”) is received through an electronic input interface of the intermediate node. The backward message is received from a next node. The next node has a next node identifier. The backward message includes the next node identifier and the session identifier. The electronic input interface is in communication with the IP network.

At step 1516, a forward association is formed between the next node identifier and the session identifier. At step 1518, the forward association is stored in memory, to maintain state information for the session. At step 1520, additional packets of the session are obtained. At step 1522, substantially all of the additional packets in the session are forwarded toward the next node, using the stored forward association. The additional packets are forwarded through the electronic output interface of the intermediate node.

At step 1524, a plurality of packets is received in a return session, or a return portion of the session, from the destination. The return session is addressed toward the originating node. At step 1526, substantially all the packets in the return session are forwarded toward the prior node, using the stored return association. The packets are forwarded through the electronic output interface.

As shown at step 1600 in FIG. 16, forwarding the lead packet 1412 toward the destination node may include accessing a routing information base having routing information for the next node. As shown at step 1602, the intermediate node may have a routing table, and forwarding the lead packet 1412 toward the destination node may include using the routing table to forward the lead packet toward the destination node. As shown at step 1604, forwarding the lead packet 1412 toward the destination node may include using the next node identifier to address the lead packet toward the next node.

The lead packet may be addressed so that a plurality of network devices receive the lead packet after it is forwarded and before the next node receives the lead packet.

An AIPR 800 and all or a portion of its components 802-824 may be implemented by a processor executing instructions stored in a memory, hardware (such as combinatorial logic, Application Specific Integrated Circuits (ASICs), Field-Programmable Gate Arrays (FPGAs) or other hardware), firmware or combinations thereof. In a similar manner, the routing device utility 510 also may be implemented by a processor executing instructions stored in a memory, hardware (such as combinatorial logic, Application Specific Integrated Circuits (ASICs), Field-Programmable Gate Arrays (FPGAs) or other hardware), firmware or combinations thereof.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of configuring an administrative domain having two or more networks, each network having at least one router, the method comprising:
programming a given configuration parameter to a local configuration setting on a given router in a given network of the administrative domain;
providing a plurality of global configuration settings for a plurality of configuration parameters in the administrative domain, the plurality of global configuration settings including a different setting for the given configuration parameter, the different setting being different from the local configuration setting;
forwarding the plurality of global configuration settings to a receiving plurality of networks in the administrative domain, the given network and a second network each being one of the receiving plurality of networks in the administrative domain, the plurality of global configuration settings specifying programming of the given configuration parameter as the different setting; and
programming the given configuration parameter to the different setting on at least one router at the second network of the receiving plurality of networks,
the given router being configured with a local configuration mode that disregards any received global configuration setting changes to the given configuration parameter after programming the given configuration parameter to the local configuration setting,
the given router being configured, when in the local configuration mode, to overwrite the given configuration parameter with the local configuration setting when previously programmed to the different setting.

2. The method as defined by claim 1 further comprising the given router receiving the plurality of global configuration settings before programming the given configuration parameter to the local configuration setting.

3. The method as defined by claim 1 further comprising the given router receiving the plurality of global configuration settings after programming the given configuration parameter to the local configuration setting.

4. The method as defined by claim 3 wherein when the given router is in the local configuration mode, the given configuration parameter is maintained as the local configuration setting on the given router of the given network after receiving the plurality of global configuration settings, the given router disregarding the different setting.

5. The method as defined by claim 1 wherein the at least one router at the second network operates in accordance with a specified format, the method further comprising translating the given configuration parameter to the specified format.

6. The method as defined by claim 1 wherein the receiving plurality of networks in the administrative domain includes all of the networks in the administrative domain.

7. The method as defined by claim 6 wherein each network of the receiving plurality of networks has a respective router that programs the given configuration parameter to the different setting after receipt of the plurality of global configuration settings.

8. The method as defined by claim 1 further comprising a configuration manager to generate the plurality of global configuration settings, the configuration manager forwarding the plurality of global configuration settings to the plurality of networks.

9. The method as defined by claim 1 wherein said programming the given configuration parameter to the prescribed setting comprises logically accessing a configuration interface of the given router to program the local configuration setting on the given router.

10. The method as defined by claim 1 wherein the given router is configured with no more configuration modes than the local configuration mode that disregards any received global configuration setting changes.

11. The method as defined by claim 1 wherein the given router is configured with a global configuration mode in which the given router programs the given configuration parameter to the different setting after receipt of the plurality of global configuration settings.

12. The method as defined by claim 10 wherein the local configuration setting is overwritten by the different setting when in the global configuration mode.

13. The method as defined by claim 1 wherein the given router is configured to maintain state information for a set of the packets that are part of a given session in a network having a plurality of nodes, the given router being configured to forward each packet in the set of packets in the given session to the same node in the network.

14. A system for configuring an administrative domain having two or more networks, each network having at least one router, the system comprising:
a given configuration interface for a given router, the given configuration interface being configured to enable programming of a given configuration parameter to a local configuration setting on the given router in a given network of the administrative domain;
a configuration manager operatively coupled with the given configuration interface, the configuration manager being configured to provide a plurality of global configuration settings for a plurality of configuration parameters in the administrative domain, the plurality of global configuration settings including a different setting for the given configuration parameter, the different setting being different from the local configuration setting;
an output operatively coupled with the configuration manager, the output being configured to forward the plurality of global configuration settings to a receiving plurality of networks in the administrative domain, the given network and a second network each being one of the receiving plurality of networks in the administrative domain, the plurality of global configuration settings specifying programming of the given configuration parameter as the different setting,
the configuration manager configured to program the given configuration parameter to the different setting on at least one router at the second network of the receiving plurality of networks,
the given configuration interface to the given router being designed to configure the given router with a local configuration mode that disregards any received global configuration setting changes to the given configuration parameter after programming the given configuration parameter to the local configuration setting,
the given configuration interface to the given router being designed, when in the local configuration mode, to overwrite the given configuration parameter with the local configuration setting when previously programmed to the different setting.

15. The system as defined by claim 14 wherein the at least one router at the second network operates in accordance with a specified format, the system further comprising a translator configured to translate the given configuration parameter to the specified format.

16. The system as defined by claim 14 wherein the receiving plurality of networks in the administrative domain includes all of the networks in the administrative domain.

17. The system as defined by claim 16 wherein each network of two or more of the receiving plurality of networks has a respective router that programs the given configuration parameter to the different setting after receipt of the plurality of global configuration settings.

18. The system as defined by claim 14 wherein the given router is configured with no more configuration modes than the local configuration mode that disregards any received global configuration setting changes.

19. The system as defined by claim 14 wherein the given router is configured with a global configuration mode in which the given router programs the given configuration parameter to the different setting after receipt of the plurality of global configuration settings.

20. The system as defined by claim 19 wherein the local configuration setting is overwritten by the different setting when in the global configuration mode.

21. The system as defined by claim 14 wherein the given router is configured to maintain state information for a set of the packets that are part of a given session in a network having a plurality of nodes, the given router being configured to forward each packet in the set of packets in the given session to the same node in the network.

22. A router configured to be part of an administrative domain having two or more networks, each network having at least one router, the router comprising:
a configuration interface configured to permit programming of a given configuration parameter to a local configuration setting; and
an input operatively coupled with the configuration interface, the input being configured to receive a plurality of global configuration settings for a plurality of configuration parameters from a configuration manager remote from the router, the plurality of global configuration settings including a different setting for the given configuration parameter, the different setting being different from the local configuration setting,
the configuration interface being designed with a local configuration mode that disregards any received global configuration setting changes to the given configuration parameter after programming the given configuration parameter to the local configuration setting,
the configuration interface being configured, when in the local configuration mode, to overwrite the given configuration parameter with the local configuration setting when previously programmed to the different setting.

23. The router as defined by claim 22 wherein the router operates in accordance with a specified format, the router further comprising translator configured to translate the given configuration parameter to the specified format.

24. The router as defined by claim 22 wherein the router is configured to maintain state information for a set of the packets that are part of a given session in a network having a plurality of nodes, the router being configured to forward each packet in the set of packets in the given session to the same node in the network.

25. The router as defined by claim 22 wherein the configuration interface is designed with no more configuration modes than the local configuration mode.

26. The router as defined by claim 22 wherein the configuration interface is configured with a global configuration mode in which the configuration interface programs the given configuration parameter to the different setting after receipt of the plurality of global configuration settings.

27. A computer program product for use on a computer system for configuring an administrative domain having two or more networks, each network having at least one router, the computer program product comprising a tangible, non-transient computer usable medium having computer readable program code thereon, the computer readable program code comprising:
program code for programming a given configuration parameter to a local configuration setting on a given router in a given network of the administrative domain;
program code for providing a plurality of global configuration settings for a plurality of configuration parameters in the administrative domain, the plurality of global configuration settings including a different setting for the given configuration parameter, the different setting being different from the local configuration setting;
program code for forwarding the plurality of global configuration settings to a receiving plurality of networks in the administrative domain, the given network and a second network each being one of the receiving plurality of networks in the administrative domain, the plurality of global configuration settings specifying programming of the given configuration parameter as the different setting; and
program code for programming the given configuration parameter to the different setting on at least one router at the second network of the receiving plurality of networks,
program code for implementing, on the given router, a local configuration mode that disregards any received global configuration setting changes to the given configuration parameter after programming the given configuration parameter to the local configuration setting,
the given router being configured, when in the local configuration mode, to overwrite the given configuration parameter with the local configuration setting when previously programmed to the different setting.

28. The computer program product as defined by claim 27 wherein the program code for providing a plurality of global configuration settings comprises program code for the given router receiving the plurality of global configuration settings before programming the given configuration parameter to the local configuration setting.

29. The computer program product as defined by claim 27 wherein the program code for providing a plurality of global configuration settings comprises program code for the given router receiving the plurality of global configuration settings after programming the given configuration parameter to the local configuration setting.

30. The computer program product as defined by claim 29 wherein when the given router is in the local configuration mode, the given configuration parameter is maintained as the local configuration setting on the given router of the given network after receiving the plurality of global configuration settings, the given router disregarding the different setting.

31. The computer program product as defined by claim 27 further comprising translating the given configuration parameter to any of a plurality of specified formats used by one of the routers in the administrative domain.
